(19) United States
(12) Patent Application Publication
(10) Pub. No.: US 2012/0207487 A1
(43) Pub. Date: Aug. 16, 2012

(54) ELECTROPHOTOGRAPHIC DEVELOPER REPLENISHMENT ALONG DIAGONAL SWATH

(76) Inventor: ERIC CARL STELTER, Pittsford, NY (US)

(21) Appl. No.: 13/025,193

(22) Filed: Feb. 11, 2011

(51) Int. Cl. G03G 15/08

(52) U.S. Cl. 399/27; 399/255; 399/258

(57) ABSTRACT

Two-component developer in an electrophotographic (EP) printer is replenished. A replenishment amount of toner is added to depleted developer in a return channel by a replenishment system adjacent to the source end of the return channel. The amount of toner replenished is an estimate of the amount of toner supplied to the latent image in a diagonal swath on the photoreceptor defined by the process surface speed of the photoreceptor and the channel speed of the return channel using the received image data, or using measurements of the respective potentials of the latent image or the respective densities of the visible image at a plurality of points in the diagonal swath on the photoreceptor.

### CROSS-REFERENCE TO RELATED APPLICATIONS

Reference is made to commonly assigned, co-pending U.S. patent application Ser. No. ______ (Docket K000026), filed concurrently herewith, entitled “DISTRIBUTED REPLENISHMENT FOR ELECTROPHOTOGRAPHIC DEVELOPER,” by Eric C. Stelter et al., and co-pending U.S. patent application Ser. No. ______ (Docket K000028), filed concurrently herewith, entitled “REPLENISHING TONER USED FROM ELECTROPHOTOGRAPHIC DEVELOPER”, by Eric C. Stelter et al., the disclosures of which are incorporated by reference herein.

### FIELD OF THE INVENTION

This invention pertains to the field of electrophotographic printing and more particularly to replenishing developer in an electrophotographic printer.

### BACKGROUND OF THE INVENTION

Electrophotography is a useful process for printing images on a receiver (or “imaging substrate”), such as a piece or sheet of paper or another planar medium, glass, fabric, metal, or other objects as will be described below. In this process, an electrostatic latent image is formed on a photoreceptor by uniformly charging the photoreceptor and then discharging selected areas of the uniform charge to yield an electrostatic charge pattern corresponding to the desired image (a “latent image”). The photoreceptor retains the latent image, e.g., on its surface or under a protective ceramic overcoat.

After the latent image is formed, charged toner particles are brought into the vicinity of the photoreceptor and are attracted to the latent image to develop the latent image into a visible image. Note that the visible image may not be visible to the naked eye depending on the composition of the toner particles (e.g., clear toner).

After the latent image is developed into a visible image on the photoreceptor, a suitable receiver is brought into juxtaposition with the visible image. A suitable electric field is applied to transfer the toner particles of the visible image to the receiver to form the desired print image on the receiver. The imaging process is typically repeated many times with reusable photoreceptors.

The receiver is then removed from its operative association with the photoreceptor and subjected to heat or pressure to permanently fix (“fuse”) the print image to the receiver. Plural print images, e.g., of separations of different colors, are overlaid on one receiver before fusing to form a multi-color print image on the receiver.

FIG. 2 shows an embodiment of a conventional development station for bringing toner particles into the vicinity of photoreceptor 25. This station uses two-component developer, also called multi-component developer. Developer 235 includes toner particles and magnetic carrier particles. Photoreceptor 25 is adjacent to toning station 23, which includes toning member 210, feed roller 220, and sump 230. Sump 230 contains developer 235. Feed roller 220 includes protrusions 225 for carrying developer from sump 230 to toning member 210. Metering skive 214 is spaced apart from toning member 210 to permit an appropriate amount of developer to pass to toning zone 217, in which toner is transported to photoreceptor 25. Mixer 237 rotates to tribocharge the toner particles against the carrier particles while mixing developer 235. An example of a system using a feed roller and mixing augers is given in U.S. Pat. No. 7,792,467, the disclosure of which is incorporated herein by reference.

Toner particles are attracted to magnetic carrier particles by electrostatic forces developed by tribocharging in sump 230. As toner particles and carrier particles are moved against each other by mixer 237, they develop opposite charges and are thus attracted to each other. The development station brings developer into proximity with the latent image on the photoreceptor. A magnetic field is applied to the magnetic carrier particles to cause them to lift towards photoreceptor 25. The toner particles attracted to the carrier particles are thus brought closer to the latent image. This increases the electrostatic force exerted on the toner particles, causing them to transfer more readily from the developer to the latent image, and thus provides a visible image which more completely fills the toner areas of the latent image.

Various schemes have been proposed for mixing toner and carrier particles to provide effective development, especially when fresh toner is added to replace toner that has been transferred to the photoreceptor 25 (“toner replenishment”). The above-referenced '467 patent uses augers in the sump to mix developer. Other systems add fresh toner to the end of a return channel where depleted developer empties into a sump or auger racetrack. However, this can lead to dusting, a phenomenon in which uncharged or relatively low-charged toner particles reach toning member 210 and become airborne due to the high kinetic energy imparted to them by toning member 210. Other schemes count pixels to determine the amount of toner to replenish, but they can also experience dusting problems.

There is a need, therefore, for an improved way of replenishing toner in a multi-component dry electrophotographic printer.

### SUMMARY OF THE INVENTION

According to an aspect of the present invention, there is provided apparatus for replenishing two-component developer in an electrophotographic (EP) printer adapted to receive image data and deposit a corresponding print image on a receiver, comprising:

a. a photoreceptor movable at a process surface speed and adapted to hold a latent image on its surface;

b. a toning member adapted to supply toner to the latent image on the photoreceptor by bringing developer containing toner particles and carrier particles into proximity with the latent image on the photoreceptor, so that toner is removed from the developer to produce depleted developer;

c. a return channel having a source end and a sink end, adapted to receive depleted developer from the toning member and transport the depleted developer towards the sink end at a channel speed;

d. a replenishment system adjacent to the source end of the return channel and adapted to selectively add toner to the return channel; and

e. a processor adapted to receive image data, automatically estimate, as a replenishment amount of toner, the amount of toner supplied to the latent image in a diagonal swath on the photoreceptor defined by the process surface speed and the channel speed using the received image data, and cause the replenishment system to add the replenishment amount of toner to the depleted developer in the return channel.

According to another aspect of the present invention, there is provided apparatus for replenishing two-component developer in an electrophotographic (EP) printer adapted to receive image data and deposit a corresponding print image on a receiver, comprising:

a. a photoreceptor movable at a process surface speed and adapted to hold a latent image on its surface;

b. a toning member adapted to supply toner to the latent image on the photoreceptor by bringing developer containing toner particles and carrier particles into proximity with the latent image on the photoreceptor, so that toner is removed from the developer to produce depleted developer;

c. a return channel having a source end and a sink end, adapted to receive depleted developer from the toning member and transport the depleted developer towards the sink end at a channel speed;

d. a replenishment system adjacent to the source end of the return channel and adapted to selectively add toner to the return channel;

e. a sensor adapted to measure the respective potentials of the latent image or the respective densities of the visible image at a plurality of points on the photoreceptor arranged along a diagonal swath on the photoreceptor defined by the process surface speed and the channel speed; and

f. a processor adapted to automatically estimate, as a replenishment amount of toner, the amount of toner supplied to the latent image in the diagonal swath using the measured potentials or densities, and cause the replenishment system to add the replenishment amount of toner to the depleted developer in the return channel.

An advantage of this invention is that it reduces dusting by providing time for fresh toner to mix into depleted developer in the return channel. Various embodiments track usage across a diagonal swath to provide the right amount of toner to a mass of depleted developer travelling down the return channel. This can provide more uniform distribution of toner throughout the developer in the sump by replenishing each mass of developer to the correct extent.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an elevational cross-section of an electrophotographic reproduction apparatus suitable for use with various embodiments;

FIG. 2 shows an embodiment of a conventional development station;

FIGS. 3 and 4 are schematic diagrams of a replenishment apparatus according to various embodiments;

FIG. 5 is a flowchart of replenishment methods according to various embodiments;

FIG. 6 shows details of diagonal swaths according to various embodiments; and

FIGS. 7A-7F show a simulation of the printing of a diagonal swath at successive points in time.

The attached drawings are for purposes of illustration and are not necessarily to scale.

### DETAILED DESCRIPTION OF THE INVENTION

As used herein, the terms “parallel” and “perpendicular” have a tolerance of ±10°.

In the following description, some embodiments will be described in terms that would ordinarily be implemented as software programs. Those skilled in the art will readily recognize that the equivalent of such software can also be constructed in hardware. Because image manipulation algorithms and systems are well known, the present description will be directed in particular to algorithms and systems forming part of, or cooperating more directly with, systems and methods described herein. Other aspects of such algorithms and systems, and hardware or software for producing and otherwise processing the image signals involved therewith, not specifically shown or described herein, are selected from such systems, algorithms, components, and elements known in the art. Given the systems and methods as described herein, software not specifically shown, suggested, or described herein that is useful for implementation of any embodiment is conventional and within the ordinary skill in such arts.

A computer program product can include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method(s) according various embodiment(s).

The electrophotographic process can be embodied in devices including printers, copiers, scanners, and facsimiles, and analog or digital devices, all of which are referred to herein as “printers.” Various embodiments described herein are useful with electrostatographic printers such as electrophotographic printers that employ toner developed on an electrophotographic receiver, and ionographic printers and copiers that do not rely upon an electrophotographic receiver. Electrophotography and ionography are types of electrostatography (printing using electrostatic fields), which is a subset of electrography (printing using electric fields).

A digital reproduction printing system (“printer”) typically includes a digital front-end processor (DFE), a print engine (also referred to in the art as a “marking engine”) for applying toner to the receiver, and one or more post-printing finishing system(s) (e.g., a UV coating system, a glosser system, or a laminator system). A printer can reproduce pleasing black-and-white or color onto a receiver. A printer can also produce selected patterns of toner on a receiver, which patterns (e.g., surface textures) do not correspond directly to a visible image. The DFE receives input electronic files (such as Postscript command files) composed of images from other input devices (e.g., a scanner, a digital camera). The DFE can include various function processors, e.g., a raster image processor (RIP), image positioning processor, image manipulation processor, color processor, or image storage processor. The DFE rasterizes input electronic files into image bitmaps for the print engine to print. In some embodiments, the DFE permits a human operator to set up parameters such as layout, font, color, paper type, or post-finishing options. The print engine takes the rasterized image bitmap from the DFE and renders the bitmap into a form that can control the printing process from the exposure device to transferring the print image onto the receiver. The finishing system applies features such as protection, glossing, or binding to the prints. The finishing system can be implemented as an integral component of a printer, or as a separate machine through which prints are fed after they are printed.

The printer can also include a color management system which captures the characteristics of the image printing process implemented in the print engine (e.g., the electrophotographic process) to provide known, consistent color reproduction characteristics. The color management system can also provide known color reproduction for different inputs (e.g., digital camera images or film images).

Electrophotographic (EP) printers typically transport the receiver past the photoreceptor to form the print image. The direction of travel of the receiver is referred to as the slow-scan, process, or in-track direction. This is typically the vertical (Y) direction of a portrait-oriented receiver. The direction perpendicular to the slow-scan direction is referred to as the fast-scan, cross-process, or cross-track direction, and is typically the horizontal (X) direction of a portrait-oriented receiver. “Scan” does not imply that any components are moving or scanning across the receiver; the terminology is conventional in the art.

In an embodiment of an electrophotographic modular printing machine useful with various embodiments, e.g., the NEXPRESS 2100 printer manufactured by Eastman Kodak Company of Rochester, N.Y., color-toner print images are made in a plurality of color imaging modules arranged in tandem, and the print images are successively electrostatically transferred to a receiver adhered to a transport web moving through the modules. Colored toners include colorants, e.g., dyes or pigments, which absorb specific wavelengths of visible light. Commercial machines of this type typically employ intermediate transfer members in the respective modules for transferring visible images from the photoreceptor and transferring print images to the receiver. In other electrophotographic printers, each visible image is directly transferred to a receiver to form the corresponding print image.

Electrophotographic printers having the capability to also deposit clear toner using an additional imaging module are also known. The provision of a clear-toner overcoat to a color print is desirable for providing protection of the print from fingerprints and reducing certain visual artifacts. Clear toner uses particles that are similar to the toner particles of the color development stations but without colored material (e.g., dye or pigment) incorporated into the toner particles. However, a clear-toner overcoat can add cost and reduce color gamut of the print; thus, it is desirable to provide for operator/user selection to determine whether or not a clear-toner overcoat will be applied to the entire print. A uniform layer of clear toner can be provided. A layer that varies inversely according to heights of the toner stacks can also be used to establish level toner stack heights. The respective color toners are deposited one upon the other at respective locations on the receiver and the height of a respective color toner stack is the sum of the toner heights of each respective color. Uniform stack height provides the print with a more even or uniform gloss.

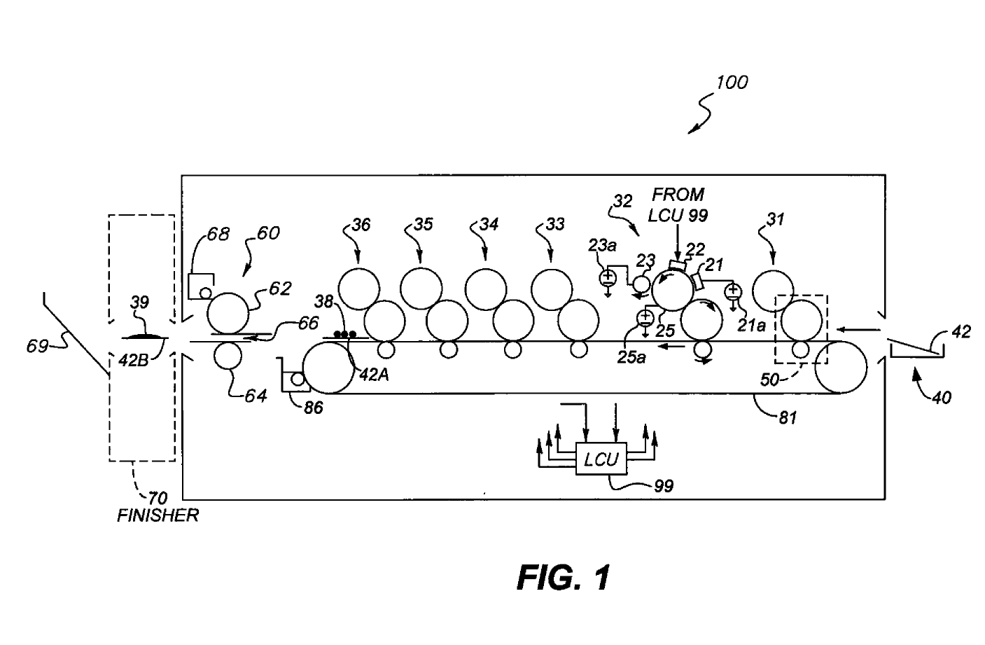

FIG. 1 is an elevational cross-section showing portions of a typical electrophotographic printer 100 useful with the present invention. Printer 100 is adapted to produce print images, such as single-color (monochrome), CMYK, or hexachrome (six-color) images, on a receiver (multicolor images are also known as “multi-component” images). Images can include text, graphics, photos, and other types of visual content. One embodiment of the invention involves printing using an electrophotographic print engine having six sets of single-color image-producing or -printing stations or modules arranged in tandem, but more or fewer than six colors can be combined to form a print image on a given receiver. Other electrophotographic writers or printer apparatus can also be included. Various components of printer 100 are shown as rollers; other configurations are also possible, including belts.

Referring to FIG. 1, printer 100 is an electrophotographic printing apparatus having a number of tandemly-arranged electrophotographic image-forming printing modules 31, 32, 33, 34, 35, 36, also known as electrophotographic imaging subsystems. Each printing module produces a single-color toner image for transfer using a respective transfer subsystem 50 (for clarity, only one is labeled) to a receiver 42 successively moved through the modules. Receiver 42 is transported from supply unit 40, which can include active feeding subsystems as known in the art, into printer 100. In various embodiments, the visible image can be transferred directly from an imaging roller to a receiver, or from an imaging roller to one or more transfer roller(s) or belt(s) in sequence in transfer subsystem 50, and thence to receiver 42. Receiver 42 is, for example, a selected section of a web of, or a cut sheet of, planar media such as paper or transparency film.

Each printing module 31, 32, 33, 34, 35, 36 includes various components. For clarity, these are only shown in printing module 32. Around photoreceptor 25 are arranged, ordered by the direction of rotation of photoreceptor 25, charger 21, exposure subsystem 22, and toning station 23.

In the EP process, an electrostatic latent image is formed on photoreceptor 25 by uniformly charging photoreceptor 25 and then discharging selected areas of the uniform charge to yield an electrostatic charge pattern corresponding to the desired image (a “latent image”). Charger 21 produces a uniform electrostatic charge on photoreceptor 25 or its surface. Exposure subsystem 22 selectively image-wise discharges photoreceptor 25 to produce a latent image. Exposure subsystem 22 can include a laser and raster optical scanner (ROS), one or more LEDs, or a linear LED array.

After the latent image is formed, charged toner particles are brought into the vicinity of photoreceptor 25 by toning station 23 and are attracted to the latent image to develop the latent image into a visible image. Note that the visible image may not be visible to the naked eye depending on the composition of the toner particles (e.g. clear toner). Toning station 23 can also be referred to as a development station. Toner can be applied to either the charged or discharged parts of the latent image.

After the latent image is developed into a visible image on the photoreceptor 25, a suitable receiver is brought into juxtaposition with the visible image. In transfer subsystem 50, a suitable electric field is applied to transfer the toner particles of the visible image to the receiver 42 to form the desired print image on the receiver 42. The imaging process is typically repeated many times with reusable photoreceptors.

The receiver 42 is then removed from its operative association with the photoreceptor and subjected to heat or pressure to permanently fix (“fuse”) the print image to the receiver. Plural print images, e.g. of separations of different colors, are overlaid on one receiver before fusing to form a multi-color print image on the receiver.

Each receiver 42, during a single pass through the six modules, can have transferred in registration thereto up to six single-color toner images to form a hexachrome image. As used herein, the term “hexachrome” implies that in a print image, various combinations of the six colors are made to form other colors on the receiver 42 at various locations on the receiver 42. That is, each of the six colors of toner can be combined with toner of one or more of the other colors at a particular location on the receiver 42 to form a color different than the colors of the toners combined at that location. In an embodiment, printing module 31 forms black (K) print images, 32 forms yellow (Y) print images, 33 forms magenta (M) print images, 34 forms cyan (C) print images, 35 forms light-black (Lk) images, and 36 forms clear images.

In various embodiments, printing module 36 forms a print image using a clear toner or tinted toner. Tinted toners absorb less light than they transmit, but do contain pigments or dyes that move the hue of light passing through them towards the hue of the tint. For example, a blue-tinted toner coated on white paper will cause the white paper to appear light blue when viewed under white light, and will cause yellows printed under the blue-tinted toner to appear slightly greenish under white light.

Receiver 42A is shown after passing through printing module 36. Print image 38 on receiver 42A includes unfused toner particles.

Subsequent to transfer of the respective print images, overlaid in registration, one from each of the respective printing modules 31, 32, 33, 34, 35, 36, receiver 42A is advanced to a fuser 60, i.e. a fusing or fixing assembly, to fuse print image 38 to receiver 42A. Transport web 81 transports the print-image-carrying receivers to fuser 60, which fixes the toner particles to the respective receivers by the application of heat and pressure. The receivers are serially de-tacked from transport web 81 to permit them to feed cleanly into fuser 60. Transport web 81 is then reconditioned for reuse at cleaning station 86 by cleaning and neutralizing the charges on the opposed surfaces of the transport web 81. A mechanical cleaning station (not shown) for scraping or vacuuming toner off transport web 81 can also be used independently or with cleaning station 86. The mechanical cleaning station can be disposed along transport web 81 before or after cleaning station 86 in the direction of rotation of transport web 81.

Fuser 60 includes a heated fusing roller 62 and an opposing pressure roller 64 that form a fusing nip 66 therebetween. In an embodiment, fuser 60 also includes a release fluid application substation 68 that applies release fluid, e.g. silicone oil, to fusing roller 62. Alternatively, wax-containing toner can be used without applying release fluid to fusing roller 62. Other embodiments of fusers, both contact and non-contact, can be employed with the present invention. For example, solvent fixing uses solvents to soften the toner particles so they bond with the receiver. Photoflash fusing uses short bursts of high-frequency electromagnetic radiation (e.g. ultraviolet light) to soften the toner. Radiant fixing uses lower-frequency electromagnetic radiation (e.g. infrared light) to more slowly soften the toner. Microwave fixing uses electromagnetic radiation in the microwave range to heat the receivers (primarily). Heat is conducted from the receivers into the toner particles thereon to soften the toner particles, so that the toner is fixed to the receiver.

The receivers (e.g. receiver 42B) carrying the fused image (e.g., fused image 39) are transported in a series from the fuser 60 along a path either to a remote output tray 69, or back to printing modules 31, 32, 33, 34, 35, 36 to create an image on the backside of the receiver, i.e. to form a duplex print. Receivers can also be transported to any suitable output accessory. For example, an auxiliary fuser or glossing assembly can provide a clear-toner overcoat. Printer 100 can also include multiple fusers 60 to support applications such as overprinting, as known in the art.

In various embodiments, between fuser 60 and output tray 69, receiver 42B passes through finisher 70. Finisher 70 performs various media-handling operations, such as folding, stapling, saddle-stitching, collating, and binding.

Printer 100 includes main printer apparatus logic and control unit (LCU) 99, which receives input signals from the various sensors associated with printer 100 and sends control signals to the components of printer 100. LCU 99 can include a microprocessor incorporating suitable look-up tables and control software executable by the LCU 99. It can also include a field-programmable gate array (FPGA), programmable logic device (PLD), microcontroller, or other digital control system. LCU 99 can include memory for storing control software and data. Sensors associated with the fusing assembly provide appropriate signals to the LCU 99. In response to the sensors, the LCU 99 issues command and control signals that adjust the heat or pressure within fusing nip 66 and other operating parameters of fuser 60 for receivers. This permits printer 100 to print on receivers of various thicknesses and surface finishes, such as glossy or matte.

Image data for writing by printer 100 can be processed by a raster image processor (RIP; not shown), which can include a color separation screen generator or generators. The output of the RIP can be stored in frame or line buffers for transmission of the color separation print data to each of respective LED writers, e.g. for black (K), yellow (Y), magenta (M), cyan (C), and red (R), respectively. The RIP or color separation screen generator can be a part of printer 100 or remote therefrom. Image data processed by the RIP can be obtained from a color document scanner or a digital camera or produced by a computer or from a memory or network which typically includes image data representing a continuous image that needs to be reprocessed into halftone image data in order to be adequately represented by the printer. The RIP can perform image processing processes, e.g. color correction, in order to obtain the desired color print. Color image data is separated into the respective colors and converted by the RIP to halftone dot image data in the respective color using matrices, which comprise desired screen angles (measured counterclockwise from rightward, the +X direction) and screen rulings. The RIP can be a suitably-programmed computer or logic device and is adapted to employ stored or computed matrices and templates for processing separated color image data into rendered image data in the form of halftone information suitable for printing. These matrices can include a screen pattern memory (SPM).

Various parameters of the components of a printing module (e.g., printing module 31) can be selected to control the operation of printer 100. In an embodiment, charger 21 is a corona charger including a grid between the corona wires (not shown) and photoreceptor 25. Voltage source 21a applies a voltage to the grid to control charging of photoreceptor 25. In an embodiment, a voltage bias is applied to toning station 23 by voltage source 23a to control the electric field, and thus the rate of toner transfer, from toning station 23 to photoreceptor 25. In an embodiment, a voltage is applied to a conductive base layer of photoreceptor 25 by voltage source 25a before development, that is, before toner is applied to photoreceptor 25 by toning station 23. The applied voltage can be zero; the base layer can be grounded. This also provides control over the rate of toner deposition during development. In an embodiment, the exposure applied by exposure subsystem 22 to photoreceptor 25 is controlled by LCU 99 to produce a latent image corresponding to the desired print image. All of these parameters can be changed, as described below.

Further details regarding printer 100 are provided in U.S. Pat. No. 6,608,641, issued on Aug. 19, 2003, to Peter S. Alexandrovich et al., and in U.S. Publication No. 2006/0133870, published on Jun. 22, 2006, by Yee S. Ng et al., the disclosures of which are incorporated herein by reference.

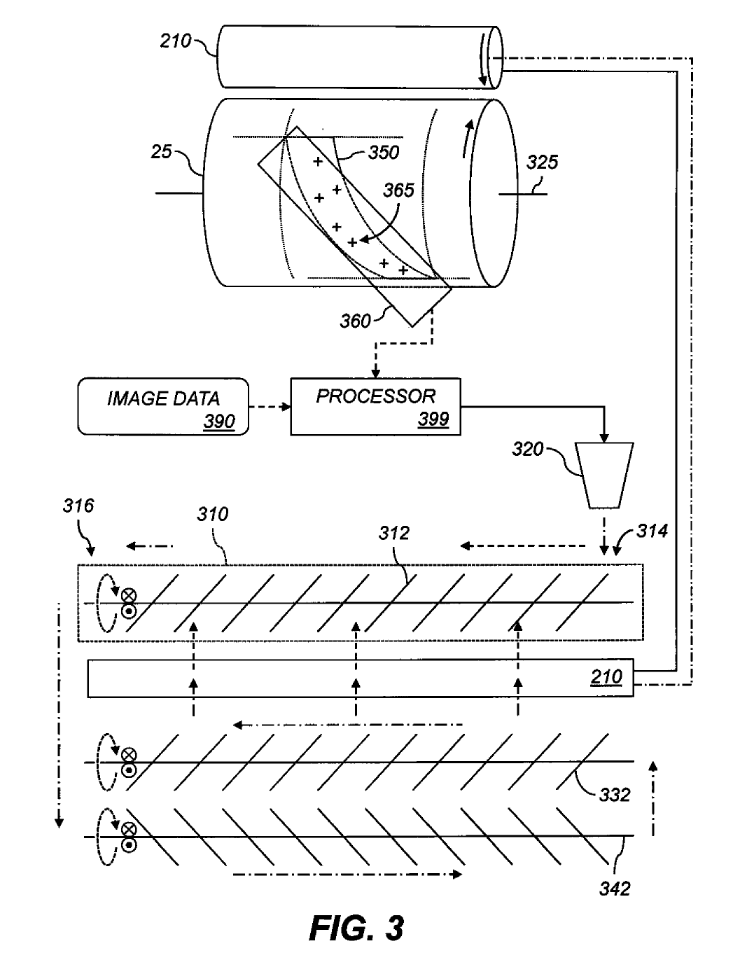

FIG. 3 is a schematic diagram of replenishment apparatus according to various embodiments. In FIG. 3, short-dashed arrows show the motion of depleted developer, i.e., developer containing carrier particles from which the toner has been removed for deposition on to the latent image. Long-dash-dot arrows show the motion of non-depleted developer. Return member 312, feed member 332 and racetrack member 342 are shown as augers, although other devices can be used; all augers are rotating with the top half into the page and the bottom half out of the page, as indicated by arrows and vector symbols. For clarity, toning member 210 is shown twice: in the context of the toner supply in the bottom half of the figure, and in the context of drum photoreceptor 25 in the top half of the figure. The lines connecting the two occurrences of part 210 show the correspondence of toner flows, as discussed below. The orientations and relative positions of components shown in the figures herein are exemplary only, and should not be construed as limiting.

In various embodiments, an apparatus for replenishing two-component or multi-component developer in an electrophotographic (EP) printer adapted to receive image data and deposit a corresponding print image on a receiver includes photoreceptor 25 (FIG. 1). Photoreceptor 25 is movable at a process surface speed that is its tangent linear velocity, not its angular velocity. Photoreceptor 25 is adapted to hold a latent image on its surface.

Two-component or multi-component developer includes toner particles or other marking particles and magnetic carrier particles. Magnetic carrier particles can be permanently-magnetized (“hard”) or not (“soft”). The developer is mixed to impart electric charge to the toner particles by triboelectrification. Two-component or multi-component developers can also include other types of particles, such as desiccants, getters, biocides, or binders; the term “two-component” is conventional in the art and does not limit the developer to exactly two types of particles.

Toning member 210 is adapted to supply toner to the latent image on photoreceptor 25. Toning member 210 brings developer containing toner particles and carrier particles into proximity with the latent image on photoreceptor 25 to provide an acceptable development rate (i.e., rate of toner mass transfer to the latent image). In an embodiment, toning member 210 is spaced 15-25 mils (0.381 mm-0.635 mm) from photoreceptor 25. The latent image attracts toner from the developer, so that toner is removed from the developer to produce depleted developer (i.e., developer with a deficit of toner particles), and to produce a visible image on photoreceptor 25. Additional toner particles are added to depleted developer to restore the developer to a suitable toner concentration for use in printing additional images; this process is referred to as “replenishment.” Replenishment also includes a period of time in which the fresh toner particles are mixed in to the depleted developer. This mixing tribocharges the toner particles against the magnetic carrier particles, and distributes the toner particles through the developer to improve image uniformity. Insufficient mixing and tribocharging can lead to dusting, a phenomenon in which toner particles depart the developer and contaminate other surfaces of the printer. Dusting is discussed further below.

Toning member 210 is shown in perspective elevation at the top of FIG. 3 and in a plan view at the bottom of FIG. 3. The dash-dot line connecting the two indicates their correspondence regarding toner being supplied to toning member 210: before photoreceptor 25 in the direction of rotation of toning member 210 at the top of FIG. 3, and from feed member 332 at the bottom of FIG. 3. The solid line connecting the two 210s indicates their correspondence regarding depleted developer being supplied to return channel 310: after photoreceptor 25 in the direction of rotation of toning member 210 at the top of FIG. 3, and to return channel 310 at the bottom of FIG. 3.

Return channel 310 has source end 314 and sink end 316. Return member 312 is present in return channel 310, and can be an auger, screw, piston, or other device, and can include zero or more paddles extending across the width of return channel 310. Return channel 310 is therefore adapted to receive depleted developer from toning member 210 and transport the depleted developer towards sink end 316 at a channel speed. The channel speed can be selected as desired, and is preferably high enough to clear depleted developer at the same volumetric flow rate at which developer is provided to toning member 210.

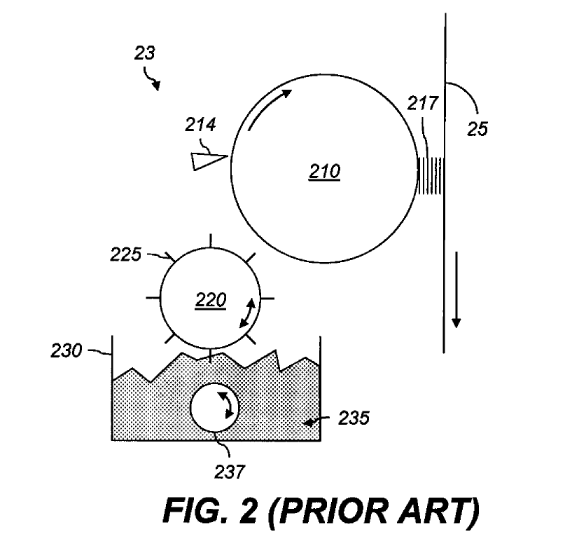

The prior art replenishes at sink end 316. However, according to various embodiments, replenishment system 320 is adjacent to source end 314 of return channel 310. Replenishment system 320 is adapted to selectively add toner, or toner and carrier particles, to the return channel. Adding toner near source end 314 (e.g., at one or more point(s) spaced apart from source end 314 by at most 25% or 20% or 10% or 5% of the length of return channel 310) rather than near sink end 316 provides additional time for toner particles and carrier particles to mix as they travel down return channel 310. This reduces dusting. Dusting is not a significant problem in return channel 310 because the kinetic energy provided to toner particles is much lower than near toning member 210. Mixing in return channel 310 charges toner particles before they reach sump 230 (FIG. 2), reducing dusting. In various embodiments, developer in return channel 310 is agitated less energetically than developer in sump 230 (FIG. 2), further reducing dusting in return channel 310. The longer the toner particles can charge in the low-agitation environment of return channel 310, the less severe dusting will be.

In the example shown here, developer travels from right to left in return channel 310, driven by return member 312 (e.g., an auger). It is then carried down to racetrack member 342 and feed member 332, which can each be any of the types of hardware described above for return member 312 (e.g., each can be an auger). Racetrack member 342 and feed member 332 drive developer containing toner particles counter-clockwise in a racetrack pattern, as shown. Additionally, feed member 332 provides developer to toning member 210. Paddles or fine-pitch sections on racetrack member 342 and feed member 332 can be used to transport developer between racetrack member 342 and feed member 332.

Processor 399 is adapted to receive image data 390 representing a print image to be produced on a receiver. Processor 399 automatically estimates a replenishment amount of toner using the received image data. The replenishment amount of toner is an estimate of the amount of toner supplied to the latent image in a diagonal swath 350 on photoreceptor 25 defined by the process surface speed and the channel speed. Processor 399 determines the replenishment amount, and then causes replenishment system 320 to add the replenishment amount of toner to the depleted developer in return channel 310. Replenishment system 320 can include a toner bottle or other container with a selectively-openable gate or selectively-operable drive auger, or both, to deposit a metered amount of toner into return channel 310. In various embodiments, replenishment system 320 includes a toner-concentration (TC) monitor to measure the TC of developer 235 (FIG. 2) in sump 230 (FIG. 2). When processor 399 determines that the measured toner concentration has fallen below a selected level, processor 399 opens a gate to permit a selected quantity of toner to enter sump 230 to mix in to developer 235.

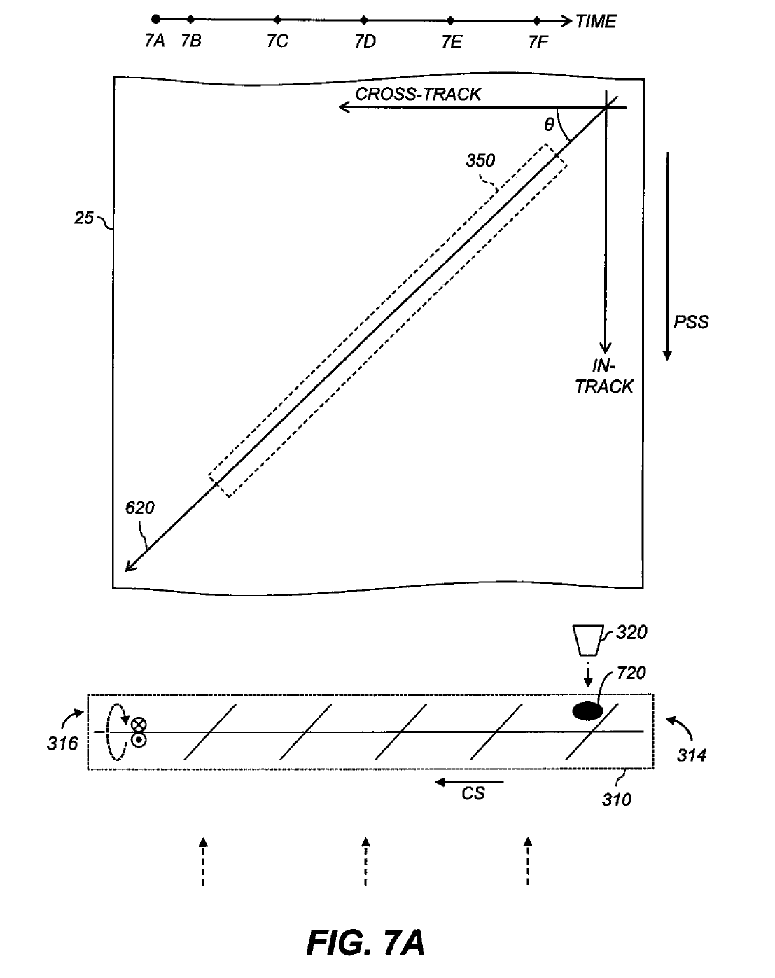

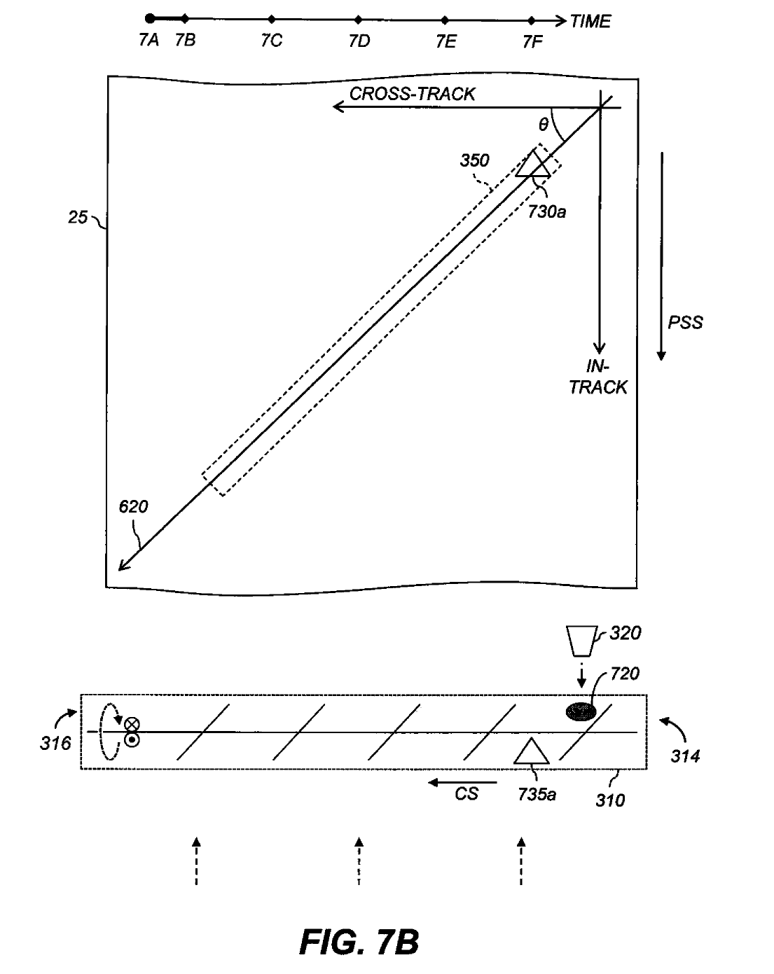

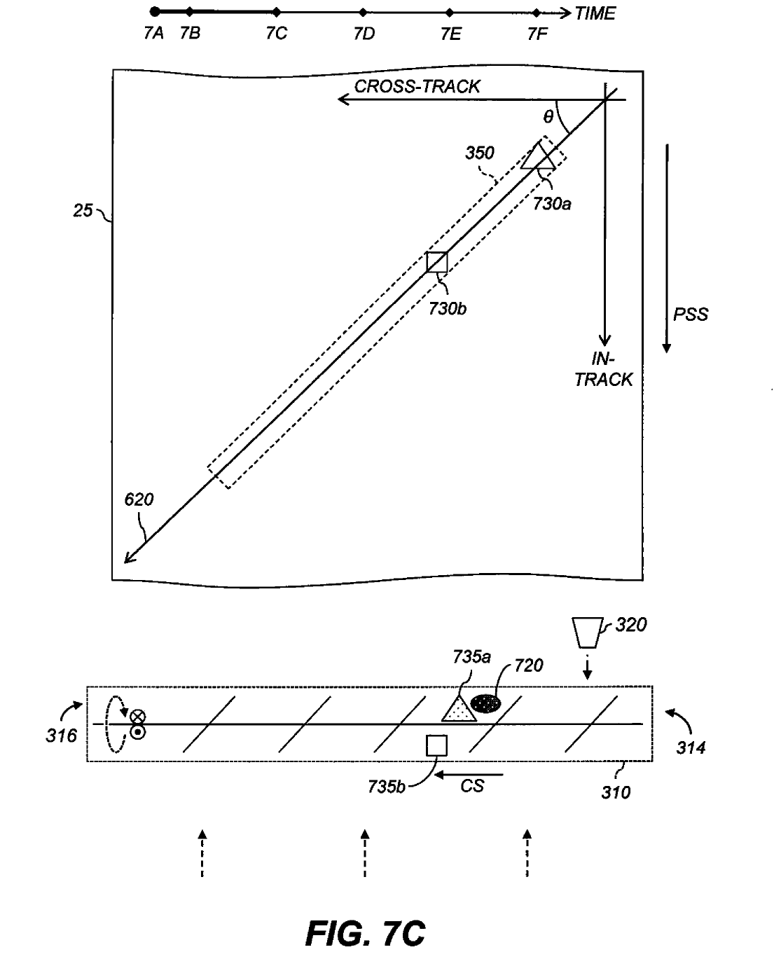

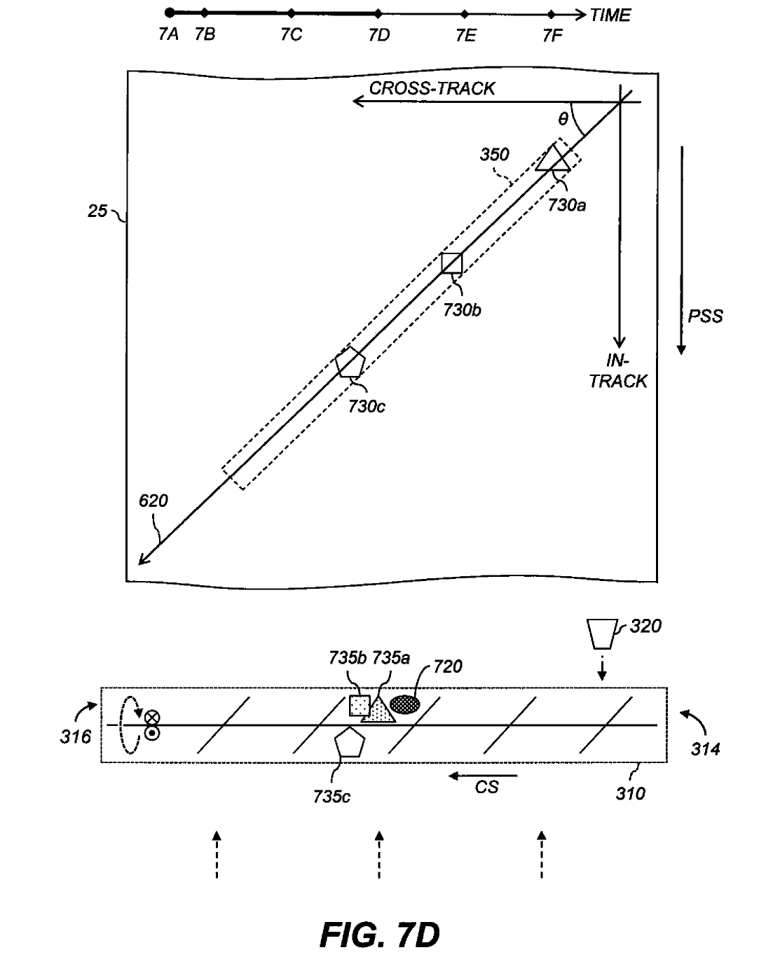

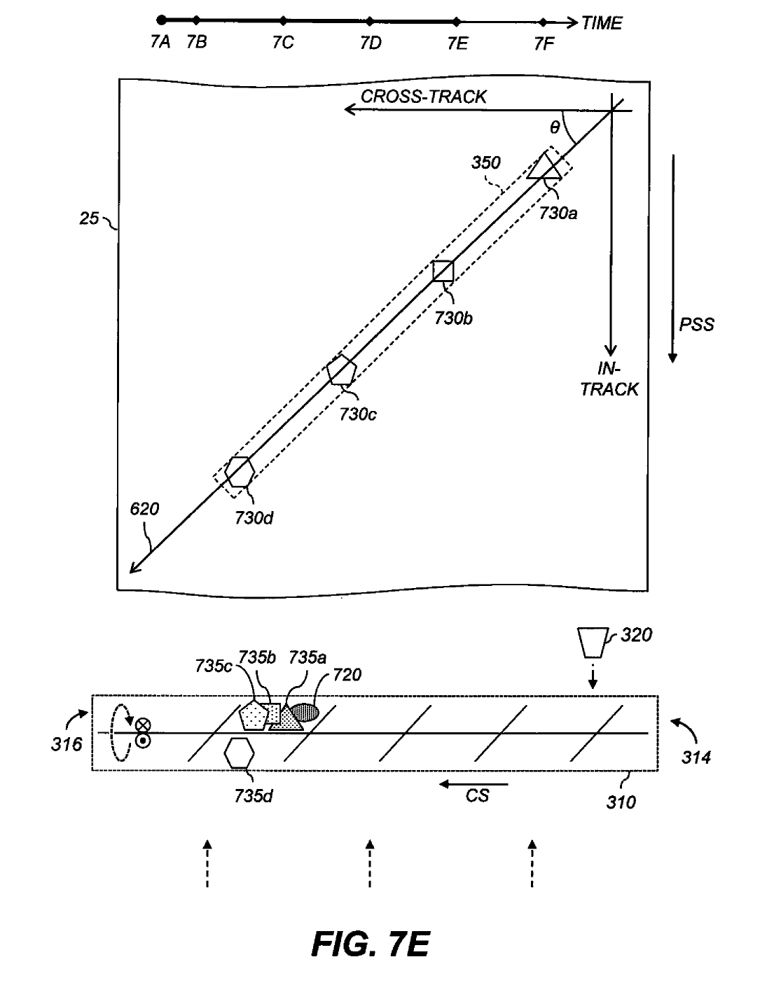

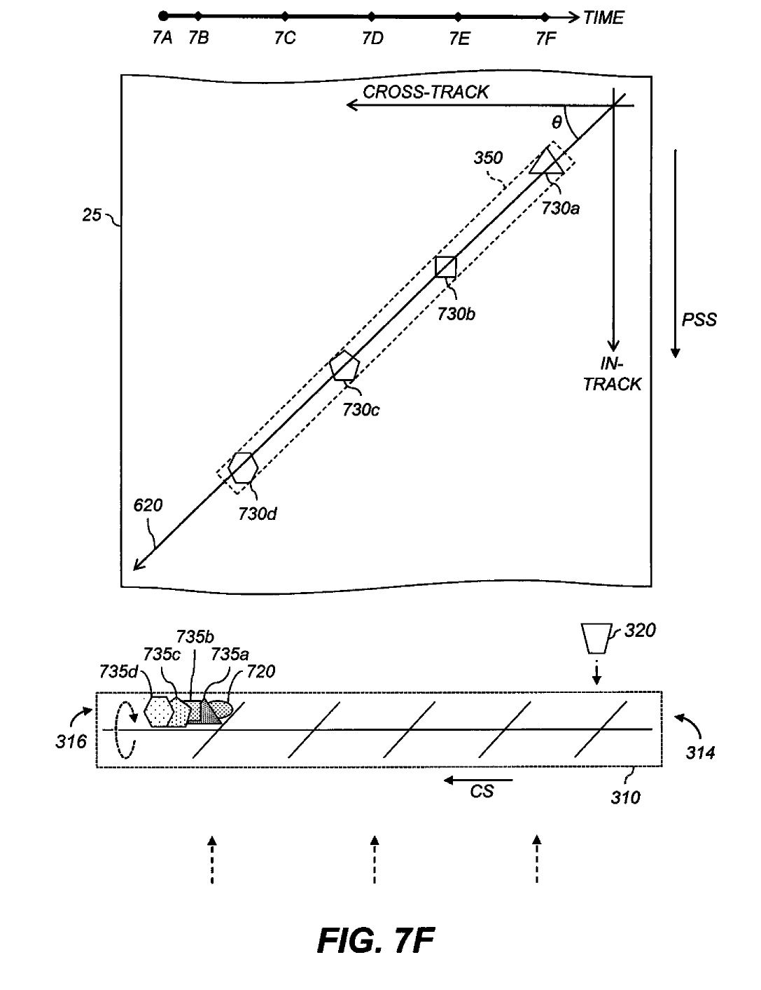

Diagonal swath 350 can extend over any percentage of the width (parallel to axis 325) of photoreceptor 25, e.g., 100% of the width, the full width of the receiver, or the full width of the receiver plus a selected margin on one or both sides. In embodiments using drum photoreceptors, diagonal swath 350 can wrap around the drum any number of times, e.g., 0.1 times, 0.5 times, one time, two times, or ten times. Diagonal swaths are discussed further below with respect to FIGS. 7A-7F.

Replenishment system 320 can add the toner directly to depleted developer or to an empty part of return channel 310 upstream of the depleted developer flow from toning member 210. In the latter case, return member 312 carries the fresh toner to the developer for mixing. As a result, when developer leaves return channel 310 near sink end 316, the developer has approximately a selected desired toner concentration (wt. % or vol. % toner, abbreviated TC).

In other embodiments, processor 399 estimates the replenishment amount of toner from measured data rather than image data. Sensor 360 measures the respective potentials of the latent image before toning, or the respective densities of the visible image after toning, at a plurality of points 365 on photoreceptor 25. Points 365 are arranged along a diagonal swath 350 on photoreceptor 25 defined by the process surface speed and the channel speed. Points 365 do not necessarily lie in a straight line or have uniform spacing. The fine dotted lines bracketing swath 350 are only to indicate the extent of swath 350 over the surface of photoreceptor 25, and do not correspond to any part or feature. Sensor 360 is spaced apart from the surface of photoreceptor 25 and can have a flat or curved face.

Processor 399 uses the measured potentials or densities from sensor 360 to estimate the amount of toner supplied to the latent image in the diagonal swath. This amount is the replenishment amount of toner. Processor 399 then causes replenishment system 320 to add the replenishment amount of toner to return channel 310 as described above.

In other embodiments, image density is measured on an intermediate drum or web between the photoreceptor and the receiver.

In various embodiments, whether estimating from image data or from measurements, the processor maps the inputs through a model that maps density, potential, or pixel value to areal toner coverage (g/cm²). This model can be constructed from empirical data gathered before shipping a printer, and be unique to a printer or shared among all printers of a particular model or family. The processor then integrates the areal toner coverage values over the image to determine the amount of toner deposited (grams).

In an example using image data, the image data includes a plurality of pixel values, each between 0 and 255. The model is a table of 256 entries, each of which is the areal density for a pixel of the corresponding pixel value (0-255). The processor knows the area of a pixel, e.g., 1.792×10⁻³ mm² for 600 dpi resolution in-track and cross-track with no inter-pixel gaps (( 1/600)² in², converted to mm²). The processor looks up the areal density for each pixel, multiplies it by the fixed pixel area, and adds it to a running sum of grams of toner deposited.

In an example using sensors, the processor divides the surface of the photoreceptor into a regular grid capturing the measured points, or into a Voronoi diagram using the measured points. Each grid square or Voronoi-diagram region (hereinafter “region”) includes one or more measured points. The point(s) in each region are averaged and the model is used to obtain the areal toner coverage of each average value. Each areal toner coverage is multiplied by the area of the corresponding region to determine grams of toner in that region; those values are summed to calculate the amount of toner deposited.

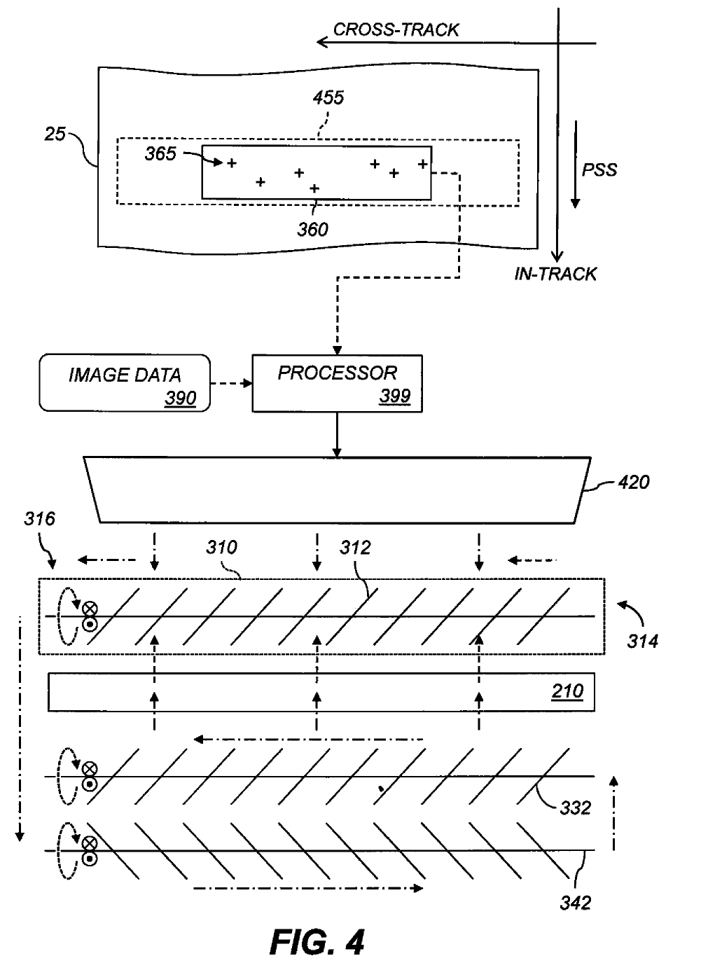

FIG. 4 is a schematic diagram of replenishment apparatus according to other embodiments. The conventions and symbols are the same as in FIG. 3, discussed above. In the example shown here, photoreceptor 25 is a web photoreceptor. Return channel 310, return member 312, source end 314, sink end 316, feed member 332, racetrack member 342, image data 390, processor 399, toning member 210, sensor 360, and points 365 are as shown in FIG. 3.

Replenishment system 420 selectively adds toner to a plurality of points along the length of return channel 310. The plurality of points can include enough points that replenishment occurs down the entire length of replenishment system 420, or in one or more slits down that length.

Processor 399 estimates a replenishment amount of toner supplied to the latent image in a cross-track swath 455 on photoreceptor 25. Swath 455 has a length in-track defined by the process surface speed. Processor 399 causes replenishment system 420 to add the replenishment amount of toner to the depleted developer in return channel 310, as described above. Replenishment can take place at different points in the plurality of points in replenishment system 420 at different times.

Cross-track swath 455 is a region of photoreceptor 25 extending parallel to the cross-track direction. In an embodiment, the length in-track of cross-track swath 455 is the process surface speed PSS divided by the frequency at which replenishment system 420 can add toner. For example, consider a simulated 60 page-per-minute (ppm), i.e., one page per second, printer printing on letter paper (8.5″×11″=215.9 mm×279.4 mm). PSS is therefore 0.2794 m/s, assuming no inter-page gaps. Let replenishment system 420 be capable of adding new toner across return channel 310 twice per page, so its frequency is 2 Hz. That is, it takes 0.5 s for toner to travel the length of replenishment system 420 so that it can be added substantially simultaneously across the width of return channel 310. The length of cross-track swath 455 is therefore 0.2794 m/s÷2 Hz=0.2794 m/s×0.5 s=0.1397 m (half a page, if replenishment system 420 stays in phase with each page printed). Processor 399 therefore estimates the toner consumed by each 0.1397 m of print and causes replenishment system 420 to add that amount of toner across return channel 310. As a result, just as depleted toner from the printing of swath 455 is being transported from toning member 210 to return channel 310, replenishment system 420 is adding the right amount of replenishment toner to return the depleted developer to a usable condition, e.g., the nominal TC. The depleted developer and replenishment toner mix as they travel down return channel 310, reducing the probability of dusting of uncharged replenishment toner.

In various embodiments, processor 399 receives image data 390 and uses image data 390 to estimate the replenishment amount of toner, as described above. In other embodiments, sensor 360 measures the respective potentials of the latent image or the respective densities of the visible image at a plurality of points on the photoreceptor arranged along the cross-track swath 455, and processor 399 uses the measurements to estimate the amount of toner to be added, as described above.

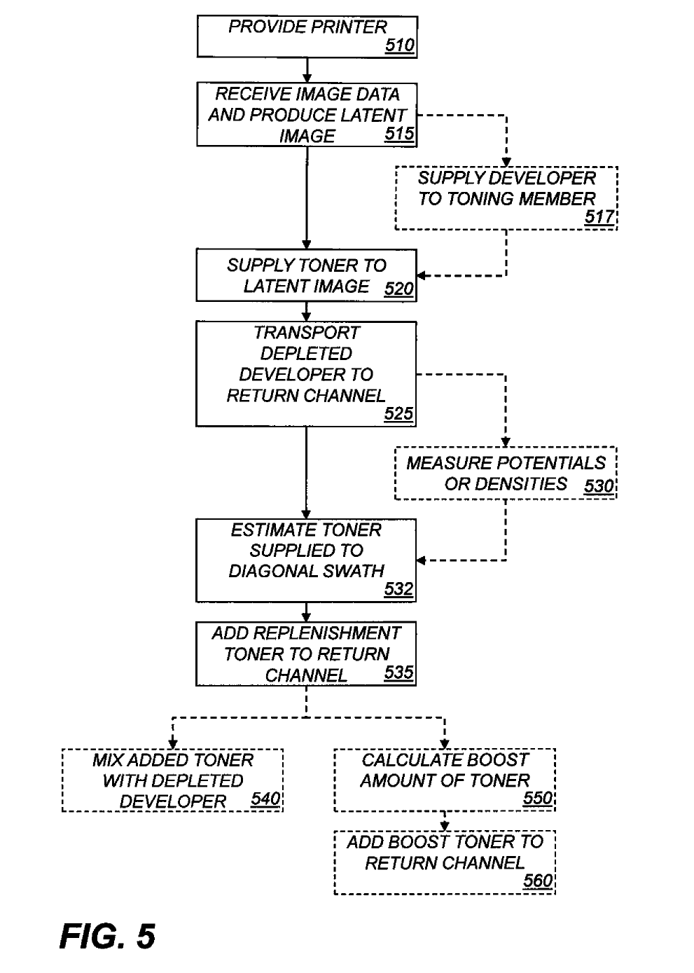

FIG. 5 is a flowchart of replenishment methods according to various embodiments. A method of replenishing two-component or multi-component developer in an electrophotographic (EP) printer adapted to deposit a print image on a receiver begins with step 510.

In step 510, the EP printer is provided. The printer has a photoreceptor movable at a process surface speed (tangent linear velocity, not angular velocity, as described above). Step 510 is followed by step 515.

In step 515, image data are received. A latent image is produced on the photoreceptor corresponding to the image data. Step 515 is followed by step 520 and optionally step 517.

In optional step 517, developer is supplied to the toning member using a feed member. The feed member moves developer containing toner particles at a feed speed. Step 517 is followed by step 520.

In step 520, toner is supplied to the latent image by bringing developer containing toner particles and carrier particles into proximity with the latent image on the photoreceptor using a toning member. As a result, toner particles are removed from the developer to produce depleted developer, and the latent image is developed into a visible image on the photoreceptor. Step 520 is followed by step 525.

In step 525, the depleted developer is transported to a return channel. The return channel moves depleted developer therein at a channel speed. Step 525 is followed by step 532 and optionally by step 530.

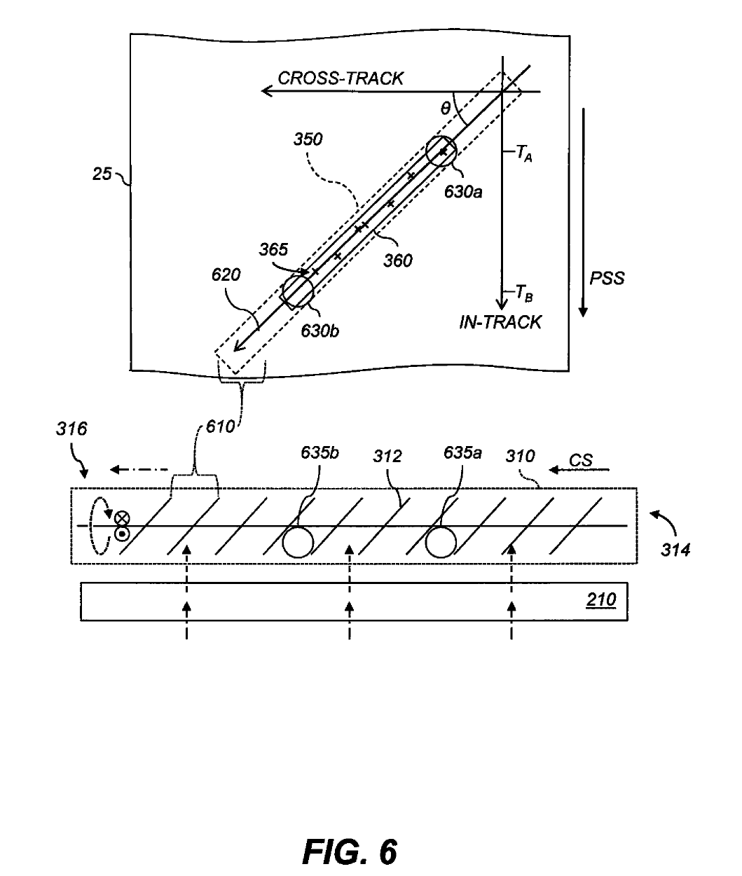

In optional step 530, the respective potentials of the latent image or the respective densities of the visible image are measured. Measurements are taken at a plurality of points on the photoreceptor arranged along a diagonal swath on the photoreceptor. The diagonal swath is defined by the process surface speed and the channel speed, as discussed below with reference to FIGS. 6-7F. Step 530 is followed by step 532.

In step 532, a processor is used to automatically estimate a replenishment amount of toner to be added to the return channel. The replenishment amount is an estimate of the amount of toner supplied to the latent image in the diagonal swath on the photoreceptor. In embodiments using step 530, the estimate is made using the measured potentials or densities. In embodiments not using step 530, the estimate is made using the received image data. The diagonal swath is defined by the process surface speed and the channel speed in either case. Step 532 is followed by step 535.

In step 535, an amount of toner equal to the replenishment amount of toner is added to the depleted developer in the return channel. This begins the process of replenishing the depleted developer, which will continue as the toner is mixed with the depleted developer. Toner can be added directly to the depleted developer, or to an empty part of the return channel, as discussed above. In various embodiments, step 535 is followed by step 540 or step 550.

In step 540, the added replenishment amount of toner is mixed with the depleted developer in the return channel. In these embodiments, toner is preferably added close to the source end of the return channel to provide as much time as possible for mixing. Toner can also be added in the middle of the return channel or at other points along the return channel upstream of the sink end of the return channel.

Steps 550 and 560 are used in embodiments in which the processor boosts the toner concentration (TC) of the developer to prepare for high-density regions which will be printed in the future. Developer passes over the toning member at a certain mass flow rate with a certain TC, so the mass of toner the toning member can supply to the latent image in a given time is proportional to the TC (neglecting other factors). In these embodiments, when the processor determines that a high-density area of the image is to be printed, it increases the TC above nominal to provide more toner to that area. Therefore, depleted developer in the return channel is replenished to the nominal TC and then boosted above nominal TC.

Specifically, in step 550, the processor calculates a boost amount of toner to be added to the return channel. In these embodiments, the processor estimates the amount of toner to be supplied to the latent image in a cross-track swath on the photoreceptor having a length in-track defined by the process surface speed. Cross-track swaths are discussed above with reference to FIG. 4. The swath is cross-track rather than diagonal because the boost toner will be mixed in the sump before passing to the toning member, so the boost toner will be distributed along the length of the toning member. The swath is selected using the channel speed, the length of the return channel, the length of the feed member, and the feed speed. Step 550 is followed by step 560.

In step 560, an amount of toner equal to the boost amount of toner is added to the depleted developer in the return channel. The boost amount of toner is added before toner is supplied to the latent image in the cross-track swath. The boost toner can be added together with the replenishment toner or separately, and can be added to an empty or developer-containing part of the return channel, as discussed above. As a result, when developer leaves return channel, it is above the nominal TC if a dense part of the image is coming soon, e.g., on this page or the next.

In an embodiment, the location of the cross-track swath is determined by looking ahead at the image data to be printed at a future time. After boost toner is added, it travels the length of the return channel at the channel speed. It then travels at least the length of the feed member at the feed speed, and in embodiments also the length of the racetrack member at the speed thereof. The time required for boost toner to travel down the return channel and back to the feed channel to be fed to the toning member is an offset added to the time at which boost toner is added to find the time of printing whose image data should be considered. For example, a 60 ppm simplex printer prints one page per second. If boost toner is added at the top of page 1 and the time for the boost toner to cycle through the sump and reach the toning member is 1.5 s, the processor checks the image data for a swath located half-way down page 2 (one second to finish page 1, then half of page 2, assuming no gaps between pages). The length of the swath is calculated using the process surface speed and knowledge or measurements of the printer behavior. The swath length is the length the photoreceptor moves past the toning member while the boost toner is passing across the toning member.

FIG. 6 shows details of diagonal swaths according to various embodiments. Diagonal swath 350 on web photoreceptor 25 includes points 365 that are measured by sensor 360, as described above. Toning member 210, return channel 310, return member 312, and source end 314 are as shown in FIG. 3.

The added replenishment amount of toner occupies a selected span 610 of the length of return channel 310. In the example shown here, return member 312 is an auger, and span 610 is one pitch of the auger. Diagonal swath 350 has a width in the cross-track direction substantially equal (e.g., within ±10%) to span 610. Long axis 620 is set at an angle θ to return channel 310. Angle θ is substantially equal (e.g., within ±10°, preferably within ±5°) to the arctangent of the quantity of the process surface speed PSS divided by the channel speed CS, i.e., ATAN2(PSS, CS). For drum photoreceptors, diagonal swath 350 can wraps around the drum. Angle θ is therefore defined at the normal to the drum through the axis of return channel 310.

For example, consider a simulated 60 page-per-minute (ppm), i.e., one page per second, printer printing on letter paper (8.5″×11″=215.9 mm×279.4 mm). PSS is therefore 0.2794 m/s, assuming no inter-page gaps. Let the return channel empty twice per page, so CS=0.4318 m/s. Let there be ten turns of the auger across the width, so span 610 is 21.59 mm. Then swath 350 has width 21.59 mm and long axis at angle θ=32.9°. This is the angle that would be traced out by a pen being driven by the auger as the receiver moved past it. The faster photoreceptor 25 or receiver 42 moves (higher PSS), the higher the angle is (approaching a straight line in the in-track direction). The faster return member 312 moves developer (higher CS), the lower the angle is (approaching a straight line in the cross-track direction).

Diagonal swath 350 is the area of the image that takes toner from a particular mass of developer in the return channel 310. Photoreceptor 25 and return member 312 preferably move continuously during printing, and as the image is printed, toner is removed from developer across the width of return channel 310. Referring to the top half of FIG. 6, areas 630a, 630b are indicated on photoreceptor 25. Area 630a is printed before area 630b. That is, toner is applied to the latent image in area 630a at an earlier time than toner is applied to the latent image in area 630b. The printing times of the centers of areas 630a, 630b are indicated on the in-track axis as T_{A} and T_{B}, respectively. Referring to the bottom half of FIG. 6, areas 635a and 635b, corresponding to areas 630a, 630b respectively, are indicated in return channel 310. The depleted developer used to supply toner to area 630a at time T_{A} is added to return channel 310 at area 635a and travels down the channel. The depleted developer used to supply toner to area 630b at time T_{B} is added to return channel 310 at area 635b and travels down the channel. Because the swath 350 has an angle calculated using PSS and CS, when the depleted developer used to supply toner to area 630b at time T_{B} is added to return channel 310 at area 635b, it is added directly to the depleted developer formerly in area 635a, which has moved down to area 635b by that time.

Therefore, the depleted developer used to print diagonal swath 350 down its length all exits return channel 310 at sink end 316 together. As a result, the replenishment amount of toner removed from that swath can be added at the source end, travel down return channel 310, pass areas 635a and 635b just as the depleted developer used to print areas 630a and 630b is being added in areas 635a, 635b, and exit at sink end 316 having approximately the desired toner concentration for fresh developer. The replenishment amount of toner has been mixed into each mass of depleted developer down the length of the swath starting from when that mass enters return channel 310, and the developer is much less likely to dust, and might be possible to use immediately.

If return member 312 does not move continuously during printing, or changes velocity during printing, diagonal swath 350 will have one or more kinks, bends, or inflection points, or will include several spans of different widths. Various embodiments are effective even in the presence of these variations. As used herein, a “swath” is a toned area of any size or shape. Replenishment toner appropriate to the content printed or to be printed in the swath is added to substantially coincide with the depleted developer used to print, or intended to print, the image in the swath. A “diagonal swath” extends an appreciable distance in the in-track and cross-track directions (e.g., >1 cm or >5 cm or >10 cm) but is not required to be straight unless otherwise explicitly noted.

FIGS. 7A-7F show a simulation of the printing of a diagonal swath at successive points in time. The timeline at the top of each figure shows the relative passage of time, with relative times identified with their corresponding figure numbers. The center of each figure shows diagonal swath 350 with long axis 620 set at angle θ on photoreceptor 25. The bottom of each figure shows return channel 310 with source end 314, sink end 316, and replenishment system 320. These are as described above.

Areas 730a, 730b, 730c, 730d are areas on photoreceptor 25 on which toner is successively deposited. Depleted developers 735a, 735b, 735c, 735d are the corresponding masses of depleted developer. For example, depleted developer 735a is the mass of developer remaining after toner was removed and deposited on area 730a of photoreceptor 25. Each area and corresponding depleted developer mass is represented graphically by a polygon: a triangle for area 730a and depleted developer 735a, a square for area 730b and depleted developer 735b, a pentagon for area 730c and depleted developer 735c, and a hexagon for area 730d and depleted developer 735d. The shading of a shape in return channel 310 is a graphic representation of its level of depletion: the darker the shading, the more toner (i.e., the less depletion).

FIG. 7A shows replenishment toner 720 being added to return channel 310 near source end 314 by replenishment system 320. This takes place at time 7A. Return channel 310 begins to transport replenishment toner 720 towards sink end 316.

In FIG. 7B, at time 7B, toner is deposited in area 730a. The corresponding depleted developer 735a is added to return channel 310.

In FIG. 7C, at time 7C, toner is deposited in area 730b. The corresponding depleted developer 735b is added to return channel 310. Between time 7B and time 7C, replenishment toner 720 and depleted developer 735a have been transported down return channel 310. Since angle θ is selected based on the channel speed CS and process surface speed PS, replenishment toner 720 and depleted developer 735a are in the same area of return channel 310 as that to which depleted developer 735b is added. Additionally, while being transported down return channel 310, replenishment toner 720 and depleted developer 735a have begun to mix, so depleted developer 735a is now somewhat replenished (as indicated by its darker shading than in FIG. 7B). Replenishment toner 720 is being mixed in to the depleted developer, as indicated by its lighter shading than in FIG. 7B.

In FIG. 7D, at time 7D, toner is deposited in area 730c. The corresponding depleted developer 735c is added to return channel 310. Between time 7C and time 7D, replenishment toner 720 and depleted developers 735a, 735b have been transported down return channel 310. Depleted developer 735a has continued to be replenished, and depleted developer 735b has begun to be replenished.

In FIG. 7E, at time 7E, toner is deposited in area 730d. The corresponding depleted developer 735d is added to return channel 310. Between time 7D and time 7E, replenishment toner 720 and depleted developers 735a, 735b, 735c have been transported down return channel 310. Depleted developers 735a, 735b have continued to be replenished, and depleted developer 735c has begun to be replenished.

FIG. 7F shows time 7F, at which time diagonal swath 350 has been printed. Between time 7E and time 7F, replenishment toner 720 and depleted developers 735a, 735b, 735c, 735d have been transported down return channel 310. Depleted developers 735a, 735b, 735c have continued to be replenished, and depleted developer 735d has begun to be replenished. Each depleted developer 735a, 735b, 735c, 735d has been at least partially replenished in return channel 310, and replenishment toner 720 has been tribocharged and mixed into depleted developers 735a, 735b, 735c, 735d, reducing its probability of dusting.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

21 charger
21a voltage source
22 exposure subsystem
23 toning station
23a voltage source
25 photoreceptor
25a voltage source
31, 32, 33, 34, 35 printing module
38 print image
39 fused image
40 supply unit
42, 42A, 42B receiver
50 transfer subsystem
60 fuser
62 fusing roller
64 pressure roller
66 fusing nip
68 release fluid application substation
69 output tray
70 finisher
81 transport web
86 cleaning station
99 logic and control unit (LCU)
100 printer
210 toning member
214 metering skive
217 toning zone
220 feed roller
225 protrusions
230 sump

### PARTS LIST—CONTINUED

235 developer
237 mixer
310 return channel
312 return member
314 source end
316 sink end
320 replenishment system
325 axis
332 feed member
342 racetrack member
350 diagonal swath
360 sensor
365 point
390 image data
399 processor
420 replenishment system
455 cross-track swath
510 provide printer step
515 receive image data and produce latent image step
517 supply developer to toning member step
520 supply toner to latent image step
525 transport depleted developer to return channel step
530 measure potentials or densities step
532 estimate toner supplied to diagonal swath step
535 add replenishment toner to return channel step
540 mix added toner with depleted developer step
550 calculate boost amount of toner step
560 add boost toner to return channel step
610 span
620 long axis

### PARTS LIST—CONTINUED

630a, 630b area
635a, 635b area
720 replenishment toner
730a, 730b, 730c, 730d area
735a, 735b, 735c, 735d depleted developer
CS channel speed
PSS process surface speed
T_{A}, T_{B} time
7A-7F time

1. Apparatus for replenishing two-component developer in an electrophotographic (EP) printer adapted to receive image data and deposit a corresponding print image on a receiver, comprising:
a. a photoreceptor movable at a process surface speed and adapted to hold a latent image on its surface;
b. a toning member adapted to supply toner to the latent image on the photoreceptor by bringing developer containing toner particles and carrier particles into proximity with the latent image on the photoreceptor, so that toner is removed from the developer to produce depleted developer;
c. a return channel having a source end and a sink end, adapted to receive depleted developer from the toning member and transport the depleted developer towards the sink end at a channel speed;
d. a replenishment system adjacent to the source end of the return channel and adapted to selectively add toner to the return channel; and
e. a processor adapted to receive image data, automatically estimate, as a replenishment amount of toner, the amount of toner supplied to the latent image in a diagonal swath on the photoreceptor defined by the process surface speed and the channel speed using the received image data, and cause the replenishment system to add the replenishment amount of toner to the depleted developer in the return channel.

2. The apparatus according to claim 1, wherein the replenishment system adds toner to the return channel at one or more point(s) spaced apart from the source end by at most 25% of the length of the return channel.

3. Apparatus for replenishing two-component developer in an electrophotographic (EP) printer adapted to receive image data and deposit a corresponding print image on a receiver, comprising:
a. a photoreceptor movable at a process surface speed and adapted to hold a latent image on its surface;
b. a toning member adapted to supply toner to the latent image on the photoreceptor by bringing developer containing toner particles and carrier particles into proximity with the latent image on the photoreceptor, so that toner is removed from the developer to produce depleted developer;
c. a return channel having a source end and a sink end, adapted to receive depleted developer from the toning member and transport the depleted developer towards the sink end at a channel speed;
d. a replenishment system adjacent to the source end of the return channel and adapted to selectively add toner to the return channel;
e. a sensor adapted to measure the respective potentials of the latent image or the respective densities of the visible image at a plurality of points on the photoreceptor arranged along a diagonal swath on the photoreceptor defined by the process surface speed and the channel speed; and
f. a processor adapted to automatically estimate, as a replenishment amount of toner, the amount of toner supplied to the latent image in the diagonal swath using the measured potentials or densities, and cause the replenishment system to add the replenishment amount of toner to the depleted developer in the return channel.

4. The apparatus according to claim 3, wherein the replenishment system adds toner to the return channel at one or more point(s) spaced apart from the source end by at most 25% of the length of the return channel.
